(19) United States
(12) Patent Application Publication
(10) Pub. No.: US 2019/0355484 A1
(43) Pub. Date: Nov. 21, 2019

(54) METHOD FOR LASER-INDUCED EXCITATION OF RADIO FREQUENCY PLASMA AT LOW AIR PRESSURE

(71) Applicant: DALIAN NATIONALITIES UNIVERSITY, Dalian (CN)

(72) Inventors: Dongping LIU, Dalian (CN); Weibin YAN, Dalian (CN); Guangjiu LEI, Dalian (CN)

(73) Assignee: DALIAN NATIONALITIES UNIVERSITY, Dalian (CN)

(21) Appl. No.: 16/463,374

(22) PCT Filed: May 18, 2017
(86) PCT No.: PCT/CN2017/084867

§ 371 Date: May 23, 2019

(30) Foreign Application Priority Data
Nov. 23, 2016 (CN) 201611042734.1

(51) Int. Cl. G21B 1/23; G21B 1/05

(52) U.S. Cl. CPC G21B 1/23; G21B 1/057

(57) ABSTRACT

A method for a laser-induced excitation of a radio frequency plasma at a low air pressure using a hardware device. The hardware device includes a pulsed laser source, a convex lens, a target material, an ion source system, and a radio frequency power supply system. When an air pressure value of the gas in the ion source system is lower than 1 Pa, and it's difficult to generate the radio frequency plasma, bombarding the target material in the ion source system by a pulsed laser beam; after the ion source system reaches a relatively high vacuum degree, providing gas to generate a plasma for the ion source system, providing the radio frequency electromagnetic field for the internal environment of the ion source system; outputting the high-intensity laser pulse; focusing the laser pulse to form a light spot with a high-power density.

### CROSS REFERENCE TO THE RELATED APPLICATIONS

This application is the national phase entry of International Application No. PCT/CN2017/084867, filed on May 18, 2017, which is based upon and claims priority to Chinese Patent Application No. 201611042734.1, filed on Nov. 23, 2016, the entire contents of which are incorporated herein by reference.

### TECHNICAL FIELD

The present invention relates to the technical field of high current neutral beam injection for nuclear fusion in tokamak, in particular to a method for a laser-induced excitation of a radio frequency plasma at a low air pressure. The method is capable of inducing the radio frequency plasma by using an interaction between a pulsed laser and a target material at the low air pressure.

### BACKGROUND

Controllable nuclear fusion has the potential to become an ideal energy source in human society. Currently, magnetic confinement fusion is considered as the most likely way to achieve a commercialization of fusion energy. For the magnetic confinement fusion, a magnetic field is used to constrain charged particles, aiming to heat a fusion fuel to a high temperature of hundreds of millions of degrees in a magnetic container to achieve a fusion reaction. The high current neutral beam injection is a main heating method for a nuclear fusion device, generally used as a secondary heating method based on an ohmic heating. The high current neutral beam injection achieves heating by injecting neutral particles into a magnetic confinement device. At present, the main neutral beam ion source includes an arc discharge ion source and a radio frequency ion source. The radio frequency ion source induces plasmas by a radio frequency electromagnetic induction discharge. Compared with the arc discharge ion source, the advantages of the radio frequency ion source are that the problem of the service life of filament is not applicable, and a long time of operation without maintenance can be realized. In addition, the radio frequency ion source works reliably and has a low cost. However, the radio frequency ion source has a problem of difficulty in ignition at a low air pressure (an air pressure less than 0.3 Pa). Therefore, solving the problem of difficulty in igniting the radio frequency ion source at the low air pressure has great significance for the development of the neutral beam technology in the nuclear fusion.

In view of the problem that the radio frequency ion source is difficult to be ignited at the low air pressure, in the present invention, electrons generated by an interaction between a focused intense pulsed laser and a tungsten target material are used as seed electrons to induce the radio frequency plasma at the low air pressure. This technology is highly operable and convenient, and does not complicate an internal structure of the system.

### SUMMARY

The present invention overcomes the deficiencies in the prior art, and provides a viable technique for a laser-induced excitation of a radio frequency plasma at a low air pressure.

In order to solve the above technical problems and realize the above objective of the present invention, technical solutions of the present invention are as follows.

A method for a laser-induced excitation of a radio frequency plasma at a low air pressure is provided. A hardware device for implementing the method includes a pulsed laser source, a convex lens, a target material, an ion source system, and a radio frequency power supply system; the convex lens is configured to focus a high-intensity pulsed laser output by the pulsed laser source; the ion source system is configured to provide a gas discharge environment; the radio frequency power supply system provides a radio frequency electromagnetic field with an adjustable power for an internal environment of the ion source system; the target material is placed in the ion source system, and a position of the target material is on an optical path of a laser output by the pulsed laser source, and is near a focus of the convex lens.

The method specifically includes the following contents: when an air pressure value of gas in the ion source system is lower than 1 Pa, and the radio frequency plasma is difficult to be generated, bombarding the target material in the ion source system by a pulsed laser beam, thereby increasing a density of a seed charge inside the ion source, and thus inducing the radio frequency plasma. First, turning on a pumping system, observing an air pressure detecting system, after the ion source system reaches a relatively high vacuum degree, turning on a gas supply system to provide a gas to generate a plasma for the ion source system, and adjusting a flow intensity of an output gas of the gas supply system to achieve a predetermined value of a gas pressure inside the ion source system; turning on the power supply system to provide the radio frequency electromagnetic field for the internal environment of the ion source system; turning on the pulsed laser source and outputting the high-intensity laser pulse; focusing the laser pulse to form a light spot with a high-power density to hit on a surface of the target material; at a moment when the light spot of the pulsed laser reaches the surface of the target material, generating a laser plasma on the surface of the target material, and providing a seed charge inside the ion source system; at a moment when the pulsed laser source outputs the high-intensity laser pulse, inducing the radio frequency plasma inside the ion source system.

In the method of the present invention, when a low air pressure and a small amount of seed charge cause a generation of the radio frequency to be difficult, the seed charge is provided by irradiating the material in a gaseous environment by using the laser spot with the high-power density, so as to increase the amount of seed charge in the gaseous environment, thereby facilitating the generation of the radio frequency plasma at the low air pressure.

Due to the above technical solution, the method for the laser-induced excitation of the radio frequency plasma at the low air pressure provided by the present invention has the following beneficial effects:

The present invention uses an interaction between the focused intense pulsed laser beam and the target material to generate the seed charge, thereby inducing the radio frequency plasma discharge at low air pressure. In the present invention, the radio frequency electromagnetic field is introduced at the low air pressure, then the target material placed inside the ion source is irradiated with the focused intense pulsed laser beam, and the radio frequency plasma is induced at the moment when the target material is irradiated by the laser beam.

### BRIEF DESCRIPTION OF THE DRAWINGS

FIG. 1 is a schematic diagram of a technical route of a laser-induced excitation of a radio frequency plasma at a low air pressure according to an embodiment of the present invention.

In the drawing: 1, pulsed laser source, 2, cavity, 3, convex lens, 4, sample stage, 5, target material, 6, ion source system, 7, gas supply system, 8, radio frequency power supply system, 9, pumping system, 10, air pressure detecting system, 11, optical path.

### DETAILED DESCRIPTION OF THE EMBODIMENTS

The present invention is further described in detail below with reference to the accompanying drawings and specific embodiments.

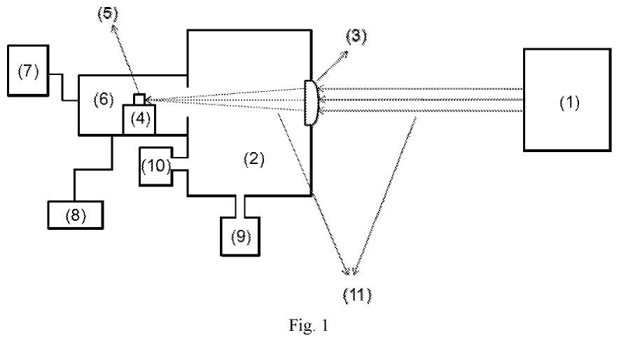

A method for a laser-induced excitation of a radio frequency plasma at a low air pressure is provided. As shown in FIG. 1, a hardware device for implementing the method includes the pulsed laser source 1, the cavity 2, the convex lens 3, the sample stage 4, the target material 5, the ion source system 6, the gas supply system 7, the radio frequency power supply system 8, the pumping system 9, and the air pressure detecting system 10.

The pulsed laser source 1 is configured to output a high-intensity pulsed laser. The cavity 2 is configured to provide a low air pressure environment.

The ion source system 6 is connected to the cavity 2 for providing a gas discharge environment. An air pressure in the ion source system 6 is close to an air pressure in the cavity 2. The ion source system 6 is connected to the gas supply system 7. The gas supply system 7 provides a gas with a controllable flow intensity for an internal environment of the ion source system 6. The sample stage 4 is placed in the ion source system 6 for mounting the target material 5 and controlling a position of the target material 5. The target material 5 is mounted on the sample stage 4. The position of the target material 5 is configured to be on an optical path 11 of a laser output by the pulsed laser source 1, and near a focus of the convex lens 3. The position of the target material 5 can be controlled by adjusting the sample stage 4. The position of the target material 5 is configured to irradiate a surface of the target material 5 by a light spot with a high-power density of the focused laser.

The gas supply system 7 is connected to the ion source system 6 to supply the gas to the internal environment of the ion source system 6.

The radio frequency power supply system 8 is connected to the ion source system 6 to provide a radio frequency electromagnetic field with an adjustable power for the internal environment of the ion source system 6.

The pumping system 9 is connected to the cavity 2 for creating low air pressure environments inside the cavity 2 and the ion source system 6. The air pressure detecting system 10 is connected to the cavity 2 for detecting air pressure values of the internal environments of the cavity 2 and the ion source system 6. The position of the target material 5 is configured to be on the optical path 11 of the laser output by the pulsed laser source 1, and near the focus of the convex lens 3.

The method specifically includes the following contents: when an air pressure value of a gas in the ion source system 6 is lower than 1 Pa, and the radio frequency plasma is difficult to be generated, the target material 5 in the ion source system 6 is bombarded by a pulsed laser beam, thereby increasing a density of a seed charge inside the ion source, and thus inducing the radio frequency plasma. The pumping system 9 is first turned on, and the air pressure detecting system 10 is observed, after the cavity reaches a relatively high vacuum degree, the gas supply system 7 is turned on to provide the gas to generate a plasma for the ion source system 6, and a flow intensity of an output gas of the gas supply system 7 is adjusted to achieve predetermined values of the gas pressures inside the ion source system 6 and the cavity 2. The power supply system 8 is turned on to provide the radio frequency electromagnetic field for the internal environment of the ion source system 6. At the time, for the gas that is difficult to be ignited at a low air pressure, when the air pressure value in the ion source system 6 is lower than a certain value, the amount of seed charge is too small to cause the radio frequency plasma to be induced. The pulsed laser source 1 is turned on to output the high-intensity laser pulse. The laser pulse is focused to form a light spot with a high-power density to hit on a surface of the target material 5. At a moment when the light spot of the pulsed laser reaches the surface of the target material 5, a laser plasma is generated on the surface of the target material 5 and the seed charge is provided inside the ion source system 6. At a moment when the pulsed laser source 1 outputs the high-intensity laser pulse, the radio frequency plasma inside the ion source system 6 is induced.

The above descriptions merely discusses the preferred embodiments of the present invention. However, the scope of the present invention is not limited thereto. Any equivalents or modifications performed by those skilled in the art according to the technical solution and the inventive conception of the present invention within the scope of the disclosed technology of the present invention, should fall within the scope of the present invention.

What is claimed is:

1. A method for a laser-induced excitation of a radio frequency plasma at a low air pressure using a hardware device, wherein the hardware device comprises a pulsed laser source, a convex lens, a target material, an ion source system, and a radio frequency power supply system; the convex lens is configured to focus a high-intensity pulsed laser output by the pulsed laser source; the ion source system is configured to provide a gas discharge environment; the radio frequency power supply system provides a radio frequency electromagnetic field with an adjustable power for an internal environment of the ion source system; the target material is placed in the ion source system, and a position of the target material is on an optical path of a laser output by the pulsed laser source, and near a focus of the convex lens; and
the method comprises the following steps:
when an air pressure of a gas in the ion source system is lower than 1 Pa, and the radio frequency plasma is difficult to be generated, bombarding the target material in the ion source system by a pulsed laser beam, thereby increasing a density of a seed charge inside the ion source, and thus inducing the radio frequency plasma;
first turning on a pumping system, observing an air pressure detecting system, after the ion source system reaches a relative high vacuum degree, turning on a gas supply system to provide the gas to generate a plasma for the ion source system, and adjusting a flow intensity of the gas output from the gas supply system to achieve a predetermined value of the air pressure inside the ion source system;
turning on the power supply system to provide the radio frequency electromagnetic field for the internal environment of the ion source system;
turning on the pulsed laser source and outputting a high-intensity laser pulse; focusing the high-intensity laser pulse to form a light spot with a high-power density to hit on a surface of the target material;
at a moment when the light spot of the pulsed laser reaches the surface of the target material, generating a laser plasma on the surface of the target material and providing the seed charge inside the ion source system; and
at a moment when the pulsed laser source outputs the high-intensity laser pulse, inducing the radio frequency plasma inside the ion source system.

2. The method for the laser-induced excitation of the radio frequency plasma at the low air pressure of claim 1, wherein,
the hardware device further comprises a cavity, a sample stage, the gas supply system, the pumping system and a gas pressure detecting system;
the cavity is configured to provide a low air pressure environment;
the ion source system is connected to the cavity; an air pressure in the ion source system is close to an air pressure in the cavity; the ion source system is connected to the gas supply system; the gas supply system provides the gas with a controllable flow intensity for the internal environment of the ion source system; the sample stage is placed in the ion source system for mounting the target material and controlling the position of the target material; the target material is mounted on the sample stage; the position of the target material is controlled by adjusting the sample stage; the position of the target material is configured to irradiate the surface of the target material by the light spot with the high-power density of the focused laser;
the gas supply system is connected to the ion source system to supply the gas to the internal environment of the ion source system;
the radio frequency power supply system is connected to the ion source system to provide a radio frequency electromagnetic field with an adjustable power for the internal environment of the ion source system; and
the pumping system is connected to the cavity for creating low air pressure environments inside the cavity and the ion source system; the air pressure detecting system is connected to the cavity for detecting air pressure values of the internal environments of the cavity and the ion source system.
